(19) United States
(12) Patent Application Publication
(10) Pub. No.: US 2011/0010251 A1
(43) Pub. Date: Jan. 13, 2011

(54) Present Box

(76) Inventor: Christine Elizabeth Silva, New South Wales (AU)

Correspondence Address: Jonathan P. O''Brien, Ph.D.;Honigman Miller Schwartz and Cohn LLP, 350 East Michigan Avenue, Suite 300, KALAMAZOO, MI, 49007, US

(21) Appl. No.: 12/405,674

(22) Filed: Mar. 17, 2009

(30) Foreign Application Priority Data
Mar. 17, 2008 (AU) AU2008901283

(51) Int. Cl. G06Q 30/00; B65D 55/14; G06F 12/00

(52) U.S. Cl. 705/14.73; 220/210; 705/26.1; 711/154; 711/E12.001

(57) ABSTRACT

A method, a container, and a computer-implemented container for selecting products and/or services as presents are disclosed. A locked container (120) is provided that is adapted to receive information about products and/or services as presents for a person associated with the container. The person inputs (130) into the locked container information about products and/or services as presents for the person. The locked container may be a box having a rectangular housing having an aperture formed in a surface with access provided to the interior of the housing by a lid, where the lid and the remainder of the housing are coupled together by a hinge. Alternatively, the locked container may be a computer-implemented container.

This application claims priority to Australian Provisional Application Ser. No. AU 2008901283 which was filed on Mar. 17, 2008. The entire contents of the aforementioned reference are incorporated herein by reference.

### TECHNICAL FIELD

The present invention relates generally to products and services that may be given as gifts or presents and in particular to methods and apparatuses for selecting products and services as gifts or presents.

### BACKGROUND

For some people, the giving of gifts is a stressful and difficult exercise. The dilemma often is what to get. People may not know what to give another person as a suitable gift or where to locate such a gift. For many people therefore gift giving can be unenjoyable and stressful. The exercise of giving a gift can involve wasted time, effort, and money because the person gives a gift that is not appropriate.

### SUMMARY

In accordance with an aspect of the invention, there is provided a method of selecting products and/or services as presents. A locked container is provided that is adapted to receive information about products and/or services as presents for a person associated with the container. The person inputs into the locked container information about products and/or services as presents for the person. The locked container may be a box having a rectangular housing having an aperture formed in a surface with access provided to the interior of the housing by a lid, where the lid and the remainder of the housing are coupled together by a hinge. Alternatively, the locked container may be a computer-implemented container.

The locked container may be unlocked by another person, the information about products and/or services as presents for a person associated with the container may be retrieved, and a present for the person associated with the locked container may be selected using the information about products and/or services as presents.

Media having recorded thereon the information about products and/or services as presents may be removed, any removed media about products and/or services as presents for which the person is given a present may be disposed of, and the remaining removed media about products and/or services as presents for which the person is not given a present may be returned to the locked container.

The locked container may be given as a present to the person associated with locked container.

In accordance with another aspect of the invention, there is provided a container for selecting products and/or services as presents, comprising: a housing having surfaces defining an internal cavity, the housing comprising an access mechanism for accessing the internal cavity, one surface of the housing having an aperture formed therein adapted for passage of media about products and/or services for presents from outside of the housing into the housing; and a lock coupled to the housing for securing the access mechanism of the housing.

The container may be a box that is rectangular in overall form with a lid coupled to the remainder of the housing by a hinge.

In accordance with still another aspect of the invention, there is provided a computer-implemented container for selecting products and/or services as presents comprising a memory for storing data and computer program instructions obtained from a computer readable medium, and a processor coupled to the memory for implementing the computer program instructions. The computer program instructions: provide a virtual container for storing information about products and/or services for presents from outside of the virtual container into the virtual container, lock the virtual container so that the owner is inhibited from retrieving information stored in the virtual container; and input information about the products and/or the services for presents into the virtual container.

### BRIEF DESCRIPTION OF THE DRAWINGS

The embodiments of the invention are described hereinafter with reference to the drawings, in which:

FIG. 1 is a flow diagram of a method of selecting products and/or services as presents in accordance with an embodiment of the invention;

FIG. 2 is an exploded perspective view of a present box, including a closed accessories drawer, in accordance with another embodiment of the invention;

FIG. 3 is a perspective view of a present box, including an opened accessories drawer, in accordance with a further embodiment of the invention; and

FIGS. 4A and 4B are a perspective view of a present box and an enlarged side view of a portion of that box, respectively, in accordance with still another embodiment of the invention.

### DETAILED DESCRIPTION

The embodiments of the invention seek to help people select appropriate gifts for other people, perhaps even the perfect gift. The present box (“Pressie Box”) has been designed to help, support and allow gift buying to be more fun and less stressful, while eliminating wasted time, effort, and money.

### Present Box

The present box in accordance with the embodiments is a box or container that holds a person's personal style and needs. That is, the present box is a portable, physical box that holds materials containing information about a person's personal style and needs. The box or container has a slot, or other suitably adapted aperture, that allows a person associated with the present box (hereinafter, the “owner”) to put into the present box printed or written media about products and/or services that the owner believes would be a suitable present for the owner. Instead of an aperture in the housing, the housing may have an access mechanism. The container comprises a housing having surfaces defining an internal cavity. The housing in turn comprises an access mechanism for accessing the internal cavity. One surface of the housing has an aperture for passage of media about products and/or services for presents from outside of the housing into the housing. A lock is coupled to the housing for securing the access mechanism of the housing. The housing is a body made from a rigid or semi-rigid material.

Essentially any type of media with information recorded on the media about products and/or services may be used, including clippings and cuttings from brochures, newspapers, flyers, catalogues, magazines, junk mail, and/or personal notes. Once placed in the present box, the owner is unable to access the media about possible gifts within the box and retrieve them. In one embodiment, the present box comprises a box with a hinged lid with a lock fastened to the lid and the rest of the box body that secures the lid in a closed position. Another person retains or keeps (hereinafter the “key keeper”) the key that actuates the lock. In an alternative embodiment, a combination lock may be employed instead of a keyed lock, where the key keeper knows or retains the combination code to unlock the combination lock but not the owner. In view of the foregoing disclosure, it will be apparent to those skilled in the art that modifications and/or substitutions may be made to the present box without departing from the scope and spirit of the invention. Any container capable of retaining media about possible gifts can be employed, provided the media can be deposited in the container and that there is a suitable locking or fastening mechanism that inhibits or prevents unauthorised access to the media.

The present box may be given initially given as a gift itself, for example, from the key keeper to the owner. The owner is not able to access the present box.

The present box may opened by the key keeper/holder to access the media about possible gifts and see what possible products and/or services might be a suitable gift for the next occasion that is coming up in respect of the owner.

By placing media about possible gifts in the present box, the use of the present box reduces or eliminates stress, worry or loss of time associated with determining suitable ideas for gift giving. The key keeper and/or another person whom is given access to the media by the key keeper are able to see from the media the gift hoped for by the owner. Further, the media may contain details of where to purchase the gift, the cost, size, colour, amongst other factors. A person is thereby able to purchase a suitable, perhaps the exact, gift sought by the owner of the present box. This may done without the embarrassment of having to ask what would the owner would like, e.g. for the person's birthday.

It's a significant advantage (even a dream) to know what is a suitable gift to buy a person. This enables a person to plan the person's shopping (knowing the exact shop to go to), and the ability to walk directly to the item, you can enter and make your purchase within minutes. There will be less or no wasted time and/or no more disappointments on the day or special occasion.

### Present Box in Use

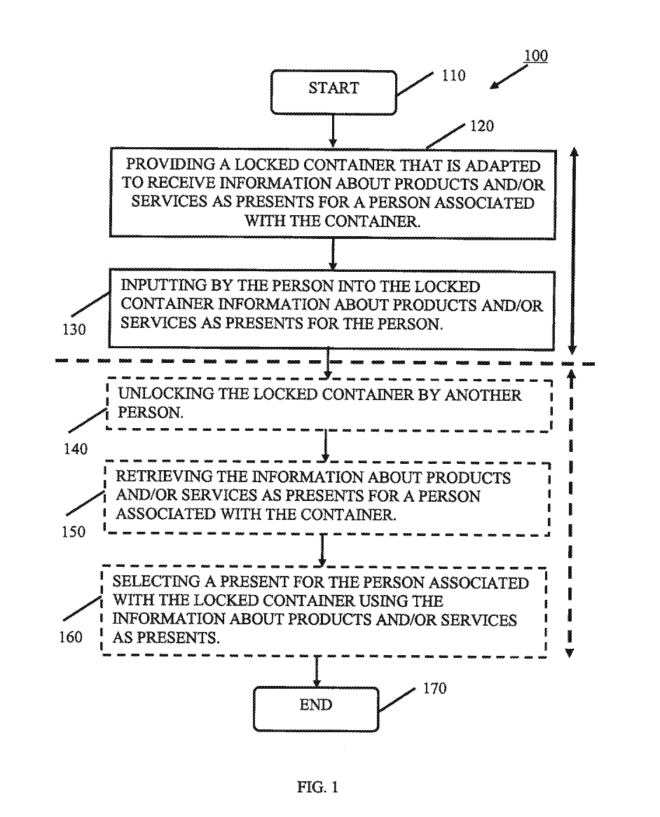

FIG. 1 is a flowchart illustrating a method 100 of selecting products and/or services as presents. Processing commences in step 110. In step 120, a locked container is provided that is adapted to receive information about products and/or services as presents for a person associated with the container. In step 130, the person inputs into the locked container information about products and/or services as presents for the person. The locked container may be a box having a rectangular housing having an aperture formed in a surface with access provided to the interior of the housing by a lid, where the lid and the remainder of the housing are coupled together by a hinge. Alternatively, the locked container may be a computer-implemented container. Processing may then terminate.

Beside steps 120 and 130 in FIG. 1 is a vertical doubleheaded, solid arrow indicating that these two steps may be performed as a separate process or sub-process. A horizontal, doubleheaded, dashed arrow separates steps 130 and 140, indicating an optional demarcation. Steps 140, 150 and 160 may be performed as another separate process or sub-process. In step 140, the locked container is unlocked by another person. In step 150, the information about products and/or services as presents for the person associated with the container is retrieved. In step 160, a present for the person associated with the locked container is selected using the retrieved information about products and/or services as presents. Processing terminates (“Ends”) in step 170.

The owner who receives a present box in accordance with the embodiments of the invention as their gift is not allowed to look inside the box. The owner must choose someone to hold the key and become the key keeper/holder.

The owner of the box can use their junk mail or a personalized note pad to place their chosen gifts into the box. Cutting out a clipping from a catalogue, for example, enables the key keeper to see the item when accessing the present box.

The key keeper has responsibility to inform others who may need suggestions/ideas on what to give the owner as a present for their next occasion.

The owner is unable to open the present box to see what media about possible gifts (including clippings and notes) have been taken from the present box. A person should only take out any media about possible gifts if the person has decided to purchase the item. Once the present has been purchased, the media about the possible gift should be disposed of.

If the present cannot be purchased, the media about possible gifts should be returned to the present box.

In accordance with the embodiments of the invention, the present box may have a particular theme. For example, such themes may include:
Anniversary present box (this can have a photograph of the couple as the design on the box e.g. in sepia, b/w, colour),
Birthday present box (to include 18^{th}, 21^{st}, 40^{th} etc),
Wedding present box,
Christening/Baptism/Name Day present box,
Donation present box,
Baby present box,
Mother present box,
Father present box,
Grandmother present box,
Grandfather present box,
Aunty/Uncle present box,
Children's present box,
Christmas present box, and
Personalised with Name present box.

The present box may be decorated with a variety of prints and designs for each box available. The lock may have the design or logo of the Pressie Box on the lock with a special style of key. Each box may have a logo and a choice of a special box or key ring to hold the key in for the key keeper/holder.

The present box may have associated accessories, including:
Pressie Box scissors,
Pressie Box note pad, and
Pressie Box Pen/Pencil

### Electronic or Computerised Present Box

In another embodiment of the invention, the present box may be implemented on a computer or electronically. A “virtual” container and a “virtual” lock can be implemented on the computer or on a server in an electronic or computer network as an intangible, electronic present box, but having properties akin to the tangible present box. The virtual present box may be deposited with, and contain, hyperlinks to retail stores, for example. Retailers and/or companies can advertise on a virtual page, for example, displaying their latest products (e.g., cell phone, game station, etc.). Information about possible gifts can be deposited in the virtual present box. A person can “cut and paste” electronic forms of media about possible gifts in the present box, e.g., from the retail site. Also, a hyperlink to a web page of a retailer/company can be deposited in the present box.

The virtual container can be implemented using a computer comprising a memory for storing data and computer program instructions obtained from a computer readable medium. A computer program product comprises a computer readable medium having recorded thereon a computer program and/or software. The computer further comprises a processor coupled to the memory for implementing the computer program instructions. The computer program instructions are executed by the processor to: provide the virtual container for storing information about products and/or services for presents from outside of the virtual container into the virtual container, lock the virtual container so that the owner is inhibited from retrieving information stored in the virtual container; and input information about the products and/or the services for presents into the virtual container.

A password may be held by a password keeper/holder (like the key keeper). Only the person having the password can access the present box. The owner is unable to view what has been deleted from the present box so the owner is not able to know what present or gift is to be given. Electronic themes can be applied to the electronic present box including wall paper, colours, fonts, photographs, messages, details and addresses of department stores, boutiques, and retail store/shop, amongst other things.

Advertising from companies may be provided on the background page for the virtual present box. Thus, when the virtual present box is opened online, the person accessing the present box may be presented with advertised products and services, e.g., electrical, computer, clothing, toys, jewellery, vacation offers (services), information about travel agents, airlines, etc. The virtual present box may also embody a calendar function so that special occasion dates can be recorded.

The electronic present box may be implemented in software that executes on a computer system or server in a network and be recorded a computer readable medium using any of a number of techniques well known to those skilled in computer related arts.

### Computer Implementation

The embodiments of the invention described hereinbefore and with reference to FIG. 1 may be implemented using a computer system, in which the method (process/sub process) of FIG. 1 may be implemented as software, such as one or more application programs executable within the computer system. In particular, the steps of the method shown in FIG. 1 can be effected by instructions in the software that are carried out within the computer system. The instructions may be formed as one or more computer program code modules, each for performing one or more particular tasks. The software may also be divided into two separate parts, in which a first part and the corresponding code modules perform the method for selecting products and/or services as presents and the corresponding code modules manage a user interface between the first part and the user. The software may be stored in a computer readable medium, including the storage devices described hereinafter, for example. The software is loaded into the computer system from the computer readable medium and then executed by the computer system. A computer readable medium having such software or computer program recorded on the computer readable medium is a computer program product. The use of the computer program product in the computer system preferably effects an advantageous apparatus for selecting products and/or services as presents.

The computer system is formed by a computer module, input devices such as a keyboard and a mouse pointer device and/or other human machine interface, and output devices including a printer, a display device and loudspeakers. The display device may be a cathode ray tube type device, an LCD monitor or other suitable device for graphically displaying air traffic control information. An external Modulator-Demodulator (Modem) transceiver device may be used by the computer module for communicating to and from a communications network via a connection. The network may be a wide-area network (WAN), such as the Internet or a private WAN. Where the connection is a telephone line, the modem may be a traditional “dial-up” modem. Alternatively, where the connection is a high-capacity (e.g., cable) connection, the modem may be a broadband modem. A wireless modem may also be used for wireless connection to the network.

The computer module typically includes at least one processor unit, and a memory unit for example formed from semiconductor random access memory (RAM) and read only memory (ROM). The module also includes a number of input/output (I/O) interfaces including an audio-video interface that couples to the video display and loudspeakers, an I/O interface for the keyboard and mouse and optionally a joystick (not illustrated), and an interface for the external modem and printer. In some implementations, the modem may be incorporated within the computer module, for example within the interface. The computer module also has a local network interface which, via a connection, permits coupling of the computer system to a local computer network, known as a Local Area Network (LAN). As also illustrated, the local network may also couple to the wide network via a connection, which would typically include a so-called “firewall” device or similar functionality. The interface may be formed by an Ethernet™ circuit card, a wireless Bluetooth™ or an IEEE 802.11 wireless arrangement.

The interfaces and may afford both serial and parallel connectivity, the former typically being implemented according to the Universal Serial Bus (USB) standards and having corresponding USB connectors. USB and Firewire are common interfaces used for connection to such a scanner as are other serial and parallel interfaces. Storage devices are provided and typically include a hard disk drive (HDD). Other devices such as a floppy disk drive and a magnetic tape drive (not illustrated) may also be used. An optical disk drive is typically provided to act as a non-volatile source of data. Portable memory devices, such optical disks (e.g., CD-ROM, DVD), USB-RAM, and floppy disks for example may then be used as appropriate sources of data to the system.

The components to of the computer module typically communicate via an interconnected bus and in a manner which results in a conventional mode of operation of the computer system known to those skilled in the art. Examples of computers on which the described arrangements can be practised include IBM-PC's and compatibles, Sunni™ Sparcstations™, Apple Mac™ or alike computer systems evolved therefrom.

Typically, the application programs discussed hereinbefore are resident on the hard disk drive, which are read and controlled in execution by the processor. Intermediate storage of such programs and any data fetched from the networks and may be accomplished using the semiconductor memory, possibly in concert with the hard disk drive. In some instances, the application programs may be supplied to the user encoded on one or more CD-ROM and read via the corresponding drive, or alternatively may be read by the user from the networks. Still further, the software can also be loaded into the computer system from other computer readable media. Computer readable media refers to any storage medium that participates in providing instructions and/or data to the computer system for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display. Through manipulation of the keyboard and the mouse, a user of the computer system and the application may manipulate the interface to provide controlling commands and/or input to the applications associated with the GUI(s).

The method of selecting products and/or services as presents may alternatively be implemented in dedicated hardware such as one or more integrated circuits performing the functions or sub functions of graphically displaying air traffic control information in an air traffic control system. Such dedicated hardware may include graphic processors, digital signal processors, or one or more microprocessors and associated memories.

### Further Present Box

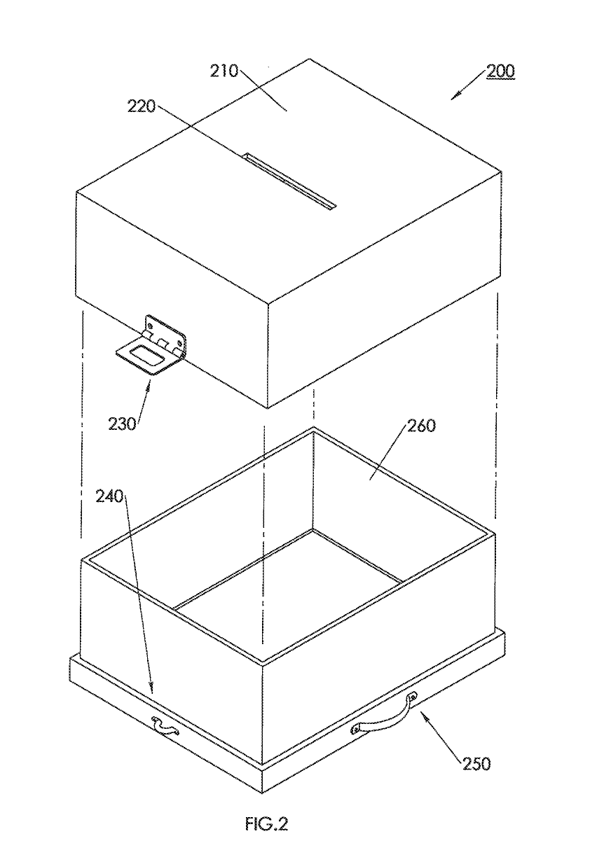

FIG. 2 illustrates a present box 200 in accordance with another embodiment of the invention. This present box 200 has an accessories drawer 250 in the bottom of the lower present box housing 260 that is disposed in a closed position. The present box 200 also has an upper housing 210 for mating engagement with the lower housing 260, in the fashion of a hat box. This example of a present box has dimensions of 150 mm by 180 mm in plan. The depth of the upper housing is 70 mm. The drawer 250 in the lower housing 260 has a depth of 15 mm. These are merely indicative measurements and variations to these dimensions can be practiced provided the tangible present box 200 is portable, and preferably manually portable. The upper housing 210 has a thin slot 220 for receiving media containing information about products and/or services as presents for the person. A hinged latch mechanism 230 is provided attached to the upper housing 210 for interlocking engagement with a rigid loop 240 securely fastened to the lower housing 260. When the two parts 230, 240 are interengaged, the parts 230, 340 can be locked with a padlock. A similar arrangement may be provided on the opposite side (not shown).

### Still a Further Present Box

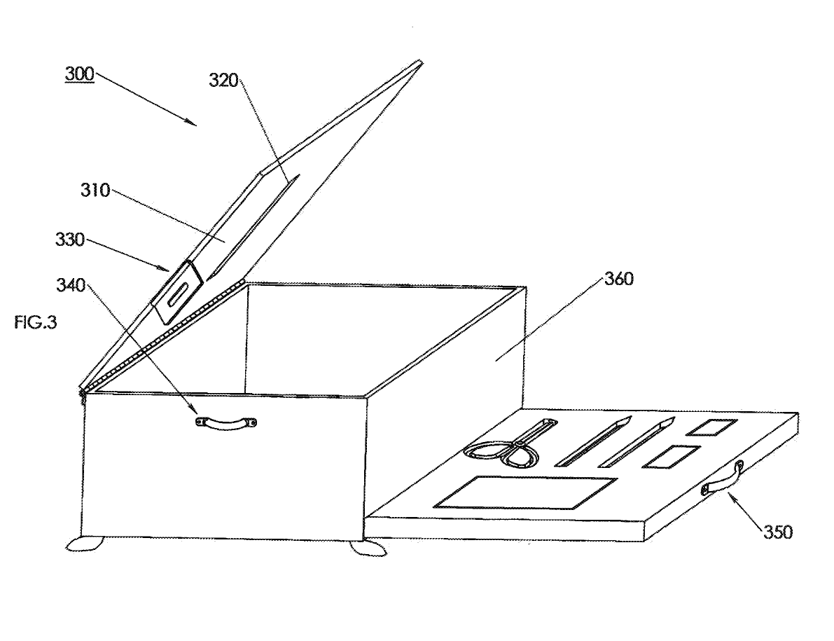

FIG. 3 illustrates a present box 300 in accordance with a further embodiment of the invention. This present box 300 has an accessories drawer 350 in the bottom of the box-like housing 360 that is disposed in a closed position. The present box 300 also has a lid 310 coupled by a hinge (not shown) to the housing 360. This example has similar dimensions to those of the present box of FIG. 2. The lid 310 has a thin slot 320 for receiving media containing information about products and/or services as presents for the person. A hinged latch mechanism 330 is provided attached to the lid 310 for interlocking engagement with a rigid loop 340 securely fastened to the housing 360. When the two parts 330, 340 are interengaged, the parts 330, 340 can be locked with a padlock. A similar arrangement may be provided on the opposite side (not shown). As shown, notepads, scissors and writing instruments can be stored in the accessories drawer 350

### Still a Further Present Box

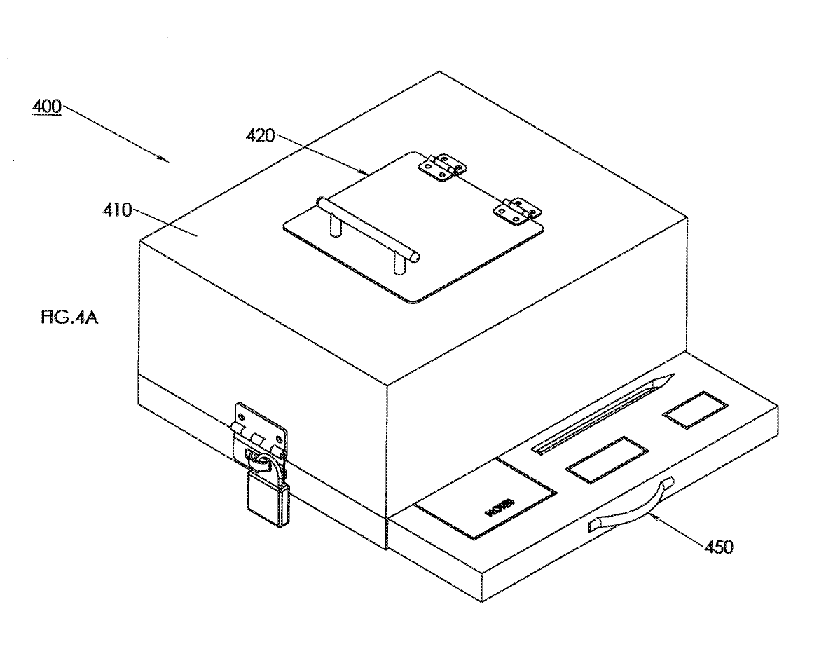

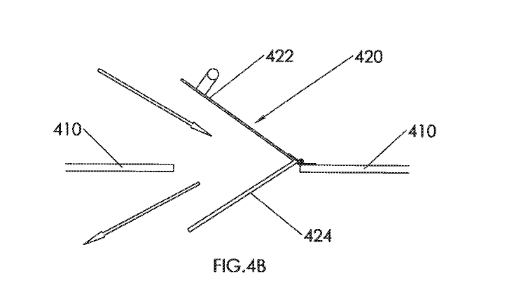

FIG. 4A and 4B illustrate a present box 400 in accordance with still another embodiment of the invention. This present box 400 is the same as that of FIG. 2 except rather than having a slot 220 in the upper housing 210, an access mechanism 420 is provided in the upper housing 410. Also, the present box 400 is depicted in FIG. 4A in a fully assembled or closed position. This present box 400 has an accessories drawer 450 in the bottom of the lower present box housing 460 that is disposed in a partially opened position. The present box 400 also has an upper housing 410 for mating engagement with the lower housing 460. The upper housing 210 has an access mechanism 420, shown in detail in FIG. 4B, for receiving media containing information about products and/or services as presents for the person. A hinged latch mechanism is provided attached to the upper housing for interlocking engagement with a rigid loop securely fastened to the lower housing. When the two parts are interengaged, the parts 230, 340 can be locked with a padlock, as shown. A similar arrangement may be provided on the opposite side (not shown). FIG. 4B shows the pivotable access mechanism 420 comprising angled door or lift up tray having two flat members 422, 424 configured at an angle relative to each other, so that in a closed position the upper member 422 of the access mechanism 420 is flush with the outer surface of the housing 410. In an opened position (as shown), a person is able to insert media into the present box 400 but is not able to access the interior of the box 400 because of the lower member 424.

Other possible mechanisms for the access mechanism as an entry deposit point include a lift up tray with a handle or push down on spring-loaded magnetic cover, a sliding tray, a turnstile mechanism, a revolving spring loaded door, a pull out deposit drawer, and a door on top or side of the present box.

Additional inclusions and features include a calendar (“My pressie box special dates”). The calendar may be a paper calendar or electronic calendar. If a paper calendar, the calendar may be issued annually with new seasons design and printed with a logo. The calendar may be suited to an individual, e.g. for a baby, may have baby designs, prints, etc. If the calendar is electronic, the calendar may be adapted to have dates of special occasions entered. SMS and electronic messages may be able to be sent to a mobile phone or computing device reminding the key holder, or multiple receivers, of the special date.

The present box may be made from one or more of wood, pewter, plastic, recycled paper, cardboard, leather, vinyl, glass, tin, silk, plant/mineral or man-made materials.

Other Aspects Other aspects of the physical present (“pressie”) box are described hereinafter, followed by description of some additional aspects of the online version of the present box.

### The Present Box- Incentive Gift Box.

The incentive gift box runs on a point system as a parenting tool to encourage good behaviour, honesty, self confidence building, and compromising/negotiating educational skills with children, for example.

The incentive box is controlled by the key keeper, who holds the key as per the present box described hereinbefore. The incentive box has a compartment/housing to deposit gift ideas and a separate housing to collect present box tokens. The owner deposits information about possible gifts into the present box incentive box. The possible gifts are monitored by the key keeper who determines the value of the gifts, eg. $1.00, $5.00, $10.00 etc and/or activities are discussed, decided, written on the present box note pad, and deposited into the compartment housing the gift ideas. When the owner is rewarded for good behaviour, the key keeper determines how many tokens are awarded for example for good behaviour and/or how many tokens will be removed for unacceptable behaviour. The token is deposited by the key keeper into the separate housing by opening the housing with the key. The owner is not able to deposit the tokens by way of an opening.

Tokens may be of any shape, colour, size and/or theme, e.g., a gold coin, star, car, butterfly etc.

The present box accessories are provided, however, in addition to the incentive gift box, with a score card chart pad. The score card chart can be a pad that is stored in the present box incentive box and can slide into a storage cavity, or be placed in an additional drawer or housing. Alternatively a score card chart can be purchased. The chart may be made of cardboard and paper, where stickers, stamps or pens are used or may be magnetic if present box magnetic tokens are used.

Present box cards can be purchased to be inserted into invitations of guest/s attending the occasion of the pressie box owner. This advises a guest that the person of the special occasion is using either the physical present box and/or the online pressie box for their gifts. The guest then knows to contact the key keeper. The key keepers contact details are recorded on the card.

### Electronic Present Box

On a website for the virtual container/electronic present box (e.g, URL: thepresentbox.com) a person can purchase an individual, a family or a friend's present box by downloading the program. Alternatively the software can be purchased on a disc. The software must be registered as per a registration identification code.

The owner build's and personalises their electronic present box with designs available according to their age and sex. The owner can choose their shape, size, colour, font, wallpaper, icons, ribbons, tokens, notepads and or other items pertaining to the present box. When creating the box, the owner needs to complete personal details of the owner being name, date of birth, address, phone number and email address. The key keeper's details also need to be entered.

Once the box is created, the owner may name the box for example My Birthday Present Box and enter the date of the special occasion. The virtual box then appears on a display screen with the name and date displayed. A calendar may also be used to record special occasions.

The owner enters information about gifts for the owner. The gift information may be entered into the present box via the notepad. The note may fold up and change shape to enter the present box. The notes may be stored inside the locked box. The information on the notepad may include the item, size, colour, shop, location, phone number, cost, quantity, and webpage address for retailers/wholesalers and or services. Once the note is selected, the note can be deleted so that repeat purchasing does not occur. Alternatively, the note may stay in the electronic present box if there is an indicator that shows the quantity 1 remaining 1. Once the gift is selected by the key keeper, the remaining quantity would go to zero to show that this item is now not available.

The key keeper may be chosen by the owner of the box. The key keeper is given access to the key which unlocks the box by a password created by the keeper. Only the key keeper is able to unlock the box. The Present Box may open (unwrap) for gifts/presents to be viewed. Friends may be allowed to view the present box, but not the owner. A temporary key may be issued to the guest/gift buyer by the key keeper only which may or may not have an expiry date. The guest can logon to thepresentbox.com website and search for a present box owner by either searching with a username, reference code, surname, address, email address or name of the present box named by the owner or any other function that allows the guest to find the owner. The guest contacts the key keeper to be issued with a temporary key, which may be by way of a pop up, email, request or comment sent to the key keeper. If the guest/gift buyer chooses to contact the key keeper, the virtual container system ensures that the guest/gift buyer remain anonymous in relation to the owner. By doing this, the owner is surprised by receiving a gift from an unexpected person. The owner is unable to select a temporary key for themselves.

When the key keeper or temporary key keeper selects the gifts that person wants to purchase for the owner, the notepad (selected gift) can be either deposited into a holding box or is unable to be selected by any other person while the gifts are being purchased. If the purchaser decides to not purchase a gift, this is returned back to the box to be available again for purchase.

If the guest/gift buyer is in another country and has been accepted to have a temporary key, the guest/gift buyer can request for the key keeper to receive delivery of the gift the guest/gift buyer has selected to purchase if the gift is bought online through the retailer/wholesaler or service provider. This eliminates overseas shipping and postage costs and reduces the possibility of the gift being lost in transit. The guest/gift buyer can also request for the key keeper to purchase the gift for the guest/gift buyer. The guest/gift buyer can pay the key keeper by way of internet banking or PAYPAL™, for example.

The owner can access a link to thepresentbox.com webpage. An icon on the website (e.g., thepresentbox.com) page can be selected to view retailers/wholesalers and services. Here, a link to the retailer/wholesalers website can be selected. While searching retailers/wholesalers and services websites, the owner can copy the URL address and paste the URL onto their present box note pad, or click on the item/product and copy and paste the item as a clipping from a catalogue. All details of the gift are entered onto the notepad. Optionally, this may be restricted to being age appropriate. For example, a child may create his/her own present box and if their age is 8 years, the child may be directed to retailers/wholesalers or services of this age group only e.g, ToyRus Big W, Target, Kmart etc. Also, specials from retailers/wholesalers or services may be received if the special is age appropriate. Children can use categories to choose from toys, fashion, accessories, camping etc. When this category is selected, the page with items/gifts pops up. Once the child has viewed and selected the gift and deposited information about the gift into their present box, this page closes and the child is returned to the retailers/wholesalers or services website with the age appropriate categories. Once the child has finished viewing this website, the only option is to then return to their present box. The child is limited to only accessing the age appropriate retailers/wholesalers or services website and is unable to further search the internet.

The owner can also enter details of their gift interests into the present search engine, for example, if the owner likes homewares and cosmetics, this information is then used to search products of retailers/wholesalers or services that are associated or any retailer/wholesaler or services that are online with the present box. This allows gift suggestions to pop up in the gift suggestion window for viewing by the owner. The owner has a choice of either: (A) selecting an item from the suggestion list and deposit this information received by way of copy and pasting the image into their present box with details of retailers/wholesalers or services including gift/item, size, qty, shop, phone number, cost, store location and website; or (B) chose to further search the retailers/wholesalers or services website to select their own gift ideas.

Gift items/selections are not limited to those found online. An owner also has the option of using the notepad provided with the present box to type any gift choices that the owner may have found from other sources such as junk mail, catalogues, magazines, newspapers, or from any form of media.

Another aspect is to offer a method to where the owner can decide to nominate an expensive gift to be purchased by several people. The gift may be separated by converting its dollar value into units. For example if a gift is $200.00 the owner may select 2×$100 units, the gift is only available to be purchased once all units have been selected.

The owner can add more present box's to their page. The owner may have My Birthday Present Box, My Wedding Present Box etc. This enables the owner to place their appropriate gift into the correct box for their special occasion.

An sms message or email may be sent to the key keepers or others, or an automatic phone call may be made to remind them of the special occasion coming up. Alternatively an email can be sent to the key keeper's or others computer. If a person is accepted as a guest or temporary key holder, that person can choose if the person would like to be notified of any special occasion.

The owner cannot see what has been purchased and can clean out the present box without knowing what is left to be purchased at any time.

Further shapes, sizes, colours, fonts, wallpaper, icons, tokens, notepads, ribbons and or other items pertaining to the present box may be available to purchase to enable the owner to have their own unique box/s.

Tokens can be purchased for the incentive present box. Upon creating the incentive present box, a person can enter the amount of tokens for each dollar value. A pop up announcement may appear, for example, if only 2 tokens are needed before the owner receives their gift.

The present box is designed so that the owner cannot see what is in the box. The present box is surprised based. This is in contrast to other systems that allow the owner of a “wish list” to look at their list and see if a gift has been purchased and or who has purchased the gift. The present box is not a retailer, but is simply a tool to look and browse other retailers/wholesalers or services either online or by entering information from other sources of media.

Only the owner may deposit a gift idea into the locked box. However, the owner cannot view the inside of the box at any time.

The key keeper may view the contents of the box but is prevented (locked out) from depositing any new gift ideas into the box. The key keeper or temporary key holder can print off the notepads of selected gifts on notepads to assist the person when the person goes shopping. The key keeper or temporary key holder can only return notepad items which had been selected for purchase back into the box, if the item was not purchased.

### Conclusion

Advantageously, the embodiments of the invention enable a person to purchase a suitable, perhaps the exact, gift that the recipient of the gift desires. The embodiments of the invention reduce or eliminate unwanted gifts. Many people who have received gifts do not relish the thought that someone has searched for a gift that is not suitable (e.g., not the right size or style) and people spend money and the gift is never used, worn, or shown because the gift is not suitable. The embodiments of the invention eliminate wasted time and allow a person to budget in terms of gift selection and purchase. The embodiments of the invention also provide choice to the owner of the present box. The owner can place cuttings, clippings, notes, etc., in the present box continually throughout the year. Also, this may help produce a surprise on the occasion of gift giving because the more media the owner places in the present box the greater the chance the owner will forget what the owner has put in box, also the owner of the pressie box is unaware of who has purchased a gift or if a gift has been purchased at all.

The foregoing describes only a small number of methods, apparatuses, containers, and computer program products for selecting products and/or services as presents in accordance with embodiments of the invention, and modifications and/or changes can be made thereto without departing from the scope and spirit of the invention, the embodiments being illustrative and not restrictive.

The claims defining the invention are as follows:

1. A method of selecting products and/or services as presents, said method comprising:
providing a locked container that is adapted to receive information about products and/or services as presents for a person associated with said container; and
inputting by said person into said locked container information about products and/or services as presents for said person.

2. The method according to claim 1, wherein said locked container comprises:
a housing having surfaces defining an internal cavity, said housing comprising an access mechanism for accessing said internal cavity, one surface of said housing having an aperture formed therein adapted for passage of media about products and/or services for presents from outside of said housing into said housing; and
a lock coupled to said housing for securing said access mechanism of said housing.

3. The method according to claim 2, wherein said locked container is a box, said housing being rectangular in overall form, and said access mechanism comprising a lid, said lid and the remainder of said housing being coupled together by a hinge, and said aperture being a slot formed in a surface of said housing.

4. The method according to claim 2 or 3, wherein said lock is a keyed lock or a combination lock.

5. The method according to claim 1, wherein said locked container is a computer-implemented container comprising:
a memory for storing data and computer program instructions obtained from a computer readable medium; and
a processor coupled to said memory for implementing said computer program instructions, said computer program instructions for:
providing a virtual container for storing information about products and/or services for presents from outside of said virtual container into said virtual container;
locking said virtual container so that said person is inhibited from retrieving information stored in said virtual container; and
inputting information about said products and/or said services for presents into said virtual container.

6. The method according to claim 1, further comprising the steps of:
unlocking said locked container by another person;
retrieving said information about products and/or services as presents for a person associated with said container; and
selecting a present for said person associated with said locked container using said information about products and/or services as presents.

7. The method according to claim 6, further comprising the steps of:
removing media having recorded thereon said information about products and/or services as presents;
disposing of any removed media about products and/or services as presents for which the person is given a present; and
returning to said locked container the remaining removed media about products and/or services as presents for which the person is not given a present.

8. The method according to claim 1, wherein media records said information about products and/or services as presents is recorded on media, said information being about at least one of where to purchase a product and/or service, the cost, size, and colour.

9. The method according to claim 1, wherein said locked container is decorated to be a/an:
Anniversary present box
Birthday present box,
Wedding present box,
Christening/Baptism/Name Day present box,
Donation present box,
Baby present box,
Mother present box,
Father present box,
Grandmother present box,
Grandfather present box,
Aunty/Uncle present box,
Children's present box,
Christmas present box, or
Personalised with Name present box.

10. The method according to claim 1, further comprising the step of giving said locked container as a present to said person associated with locked container.

11. The method according to claim 1, further comprising the step of retaining a key, combination or password by another person.

12. The method according to claim 11, further comprising the step of designating said other person to retain said key, combination or password by said person associated with said locked container.

13. A container for selecting products and/or services as presents, comprising:
a housing having surfaces defining an internal cavity, said housing comprising an access mechanism for accessing said internal cavity, one surface of said housing having an aperture formed therein adapted for passage of media about products and/or services for presents from outside of said housing into said housing; and
a lock coupled to said housing for securing said access mechanism of said housing.

14. The container according to claim 13, wherein said housing is a body made from a rigid or semi-rigid material.

15. The container according to claim 13, wherein said container is a box, said housing being rectangular in overall form, and said access mechanism comprising a lid, said lid and the remainder of said housing being coupled together by a hinge, said aperture being a slot formed in a surface of said housing.

16. The container according to claim 13, further comprising media about products and/or services disposed within said housing.

17. The container according to claim 13 or 16, wherein said media comprises at least one of clippings and cuttings from brochures, newspapers, flyers, catalogues, magazines, junk mail, and/or personal notes.

18. The container according to claim 13 or 16, wherein said media contains information about at least one of where to purchase a product and/or service, the cost, size, and colour.

19. The container according to claim 13, wherein said lock is a keyed lock or combination lock.

20. The container according to claim 13, wherein said container is decorated to be a/an:
Anniversary present box
Birthday present box,
Wedding present box,
Christening/Baptism/Name Day present box,
Donation present box,
Baby present box,
Mother present box,
Father present box,
Grandmother present box,
Grandfather present box,
Aunty/Uncle present box,
Children's present box,
Christmas present box, and
Personalised with Name present box.

20. The container according to claim 12, wherein the access member is a slot formed in a surface of said housing.

21. The container according to claim 12, wherein the access member is a lift up tray connected pivotably to a surface of said housing.

22. A computer-implemented container for selecting products and/or services as presents, comprising:
a memory for storing data and computer program instructions obtained from a computer readable medium; and
a processor coupled to said memory for implementing said computer program instructions, said computer program instructions for:
providing a virtual container for storing information about products and/or services for presents from outside of said virtual container into said virtual container;
locking said virtual container so that the owner is inhibited from retrieving information stored in said virtual container; and
inputting information about said products and/or said services for presents into said virtual container.

23. The computer-implemented container according to claim 22, wherein said container is implemented on a server in a computer or electronic network.

24. The computer-implemented container according to claim 22, wherein one of said computer program instructions is for unlocking said virtual container to retrieve information about products and/or services for a present for another person.

25. The computer-implemented container according to claim 24, wherein a password must be input to unlock said container.

26. The computer-implemented container according to claim 22, wherein said information about products and/or services for presents comprises a hyperlink to a retail store.

27. The computer-implemented container according to claim 22 or 26, wherein commercial advertising is provided on a background web page for said container.

28. The computer-implemented container according to claim 22, wherein opening and accessing online said computer-implemented container causes commercial advertising about products and/or services to presented.

29. The computer-implemented container according to claim 22, wherein said information about products and/or services for presents comprises commercial advertising.

30. The computer-implemented container according to claim 22, wherein electronic themes are applied to said container including wall paper, colours, fonts, photographs, messages, details and addresses of department stores, boutiques, and retail store/shop, amongst other things.
